(19) United States
(12) Patent Application Publication
(10) Pub. No.: US 2004/0230460 A1
(43) Pub. Date: Nov. 18, 2004

(54) Secondary loss expense coverage

(76) Inventors: Bruce Bradford Thomas, Trumbull, CT (US); Lester Ware Preston III, Darien, CT (US)

Correspondence Address: Bruce Bradford Thomas, 145 Lake Avenue, Trumbull, CT, 06611, US

(21) Appl. No.: 10/647,078

(22) Filed: Aug. 22, 2003

Related U.S. Application Data
(60) Provisional application No. 60/411,260, filed on Sep. 16, 2002.

(51) Int. Cl. G06F 17/60

(52) U.S. Cl. 705/4

(57) ABSTRACT

A method for underwriting and adjusting loss experience based on the premiums paid for and the losses recovered from an insurance policy.

### CROSS-REFERENCE TO RELATED APPLICATIONS

This application claims the benefit of Provisional Patent Application No. 60/411,260, filed on Sep. 16, 2002 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to providing coverage for loss expenses when a separate contract of insurance is in-force.

2. Background of the Invention

Insurance is a means by which the risk of loss is contractually shifted from the insured to the insurer. Under this contractual arrangement, the insured pays a premium to the insurer for agreeing to bear some potential loss that the insured faces.

Underwriting

Not all potential losses are insurable and an insurer must expend significant efforts to ensure that applicants have met its standards. This process is known as underwriting. Although such standards encompass many elements, there are two elements that are of particular importance. The causes of loss that are covered by an insurance policy must be defined and the policy must carry a premium that is reasonable in relation to the potential for loss.

Because the terms of insurance are relatively complicated and the coverage definition is critically important to both the insurer and insured, extensive consideration is warranted. Since insurers have much greater expertise in this area, most insurance buyers use insurance agents and brokers to help them make good purchasing decisions.

Loss Adjustment

Substantiating insurable losses can be very expensive for both insureds and insurers. Insurers categorize their costs associated with determining whether losses occurred and to what extent they are covered under the insurance policies that they write as loss adjustment expenses.

In instances where coverage exists, claimants must spend considerable effort identifying and substantiating their losses. For large claims, it is not unusual for individuals and companies to hire their own adjusters and accountants to ensure that they get the most out of their insurance.

Loss Definition and Valuation

Insurance works best in instances where the definition of loss is obvious and the amount of loss is clear. If a loss is not easy to define or prove, it should not be insured because it will result in unduly complex coverage terms, disagreements over coverage interpretation, and difficulties in proving and quantifying losses. Because insurance is based on the principle of indemnity, it is impossible to obtain a reimbursement for a loss without substantiating the amount of the loss. For most losses this is problematic, and for many losses this is impossible.

To be eligible to receive insurance payments, insurance buyers must be able to prove that they had losses and that those losses fit within the coverage definition of their insurance. Losses can be categorized in many different ways such as life, health, property, casualty, etc. More generally, losses can be categorized as being direct or collateral.

A direct loss is essentially the loss itself A collateral loss, sometimes referred to as an indirect or consequential loss, is engendered by the same event that produces the direct loss or by the direct loss itself For example, the direct loss of a factory due to a fire would be the cost of rebuilding the factory. The collateral losses would be all of the costs associated with the inconvenience of not having a workable factory. Direct losses, such as the physical cost of the buildings in this example, are typically much easier to estimate than collateral losses such as lost income or extra expenses that may result from such an event. Management and employees must spend time trying to recover from this event, and there is always a significant amount of opportunity cost that can never be adequately assessed.

Consider for example the loss of an automobile. Since it is a physical thing, it should be obvious that there was a loss and the extent of that loss. Nevertheless, the collateral costs (for example lost time and other expenses) associated with fixing or replacing the car are not typically covered by insurance. Similarly, insurance may cover the direct cost of paying for and defending against a liability claim, but it typically would not cover the costs necessary to restore an entity's reputation via an advertising program or to institute new practices and procedures.

While collateral losses vary in size depending on the specifics of the loss, it is clear that they occur with every type of insurable loss. In most cases, companies and individuals are not insured against collateral losses because these losses are too difficult to define in advance or prove after the fact to make an insurance transaction viable for both insurers and insurance buyers.

Furthermore, policyholders often have considerable discretion over collateral losses, making them impossible to quantify and subject to significant moral hazard. Since collateral losses are becoming an ever larger part of most companies' loss experience, it is no wonder that companies are increasingly frustrated with insurance.

Moral Hazard

Because insurance limits are often over a hundred times more than insurance premiums, the insured's personal habits, morals, and attitude toward losses are very important. Insurers attempt to reduce moral hazard by instituting deductibles, coinsurance clauses, and reduce insurable limits. This may dissuade applicants who are more predisposed to losses from selecting a given insurer, and it helps change attitudes toward potential losses by forcing insureds to retain a larger share of those losses. Unfortunately, each of these measures also means that the insured is never fully compensated for a loss. While insurers may have reduced moral hazard, they have done so at the cost of making insurance less valuable to the insured.

Agreed Value

Even when it is relatively easy to substantiate that a direct loss has occurred, it is not always easy to determine the value of that loss. In relatively simple cases, the insured must show receipts, appraisal documents, or other evidence that would substantiate value. Often appraisers must be called in to provide their opinions about value.

In many cases, the value of something may be open to interpretation. One technique that insurers have employed in circumstances where losses are relatively easy to substantiate but difficult to value, is to objectify the loss value at the time a policy is written.

Life policies operate on the principal of agreed value. Rather than attempt to dispute how much a life is worth after it is over, insurers and insureds agree to a certain value up-front and base premiums on that value. This principle is also employed for certain very special risks such as the value that was placed on Betty Grable's legs or the successful launch of an Ariane rocket.

Inventory insurance is another example of this principle. With inventory it is generally accepted that different types of companies have incurred costs that are greater than the purchase price of the goods they own. From an economic perspective, the value is not the invoice cost but the replacement cost of the inventory at a particular stage in the production and retailing process.

Rather than dispute this point, insurers and insureds often agree to a stated percentage above the purchase price of the goods. Under this arrangement, the insurer and the insured increase the limit of the insurance to some commercially reasonable amount, and the price of this coverage is increased to take account of the higher loss valuation. Thus, if the insured chooses to buy this extra coverage in an amount of 10% and has a loss, the insured will be paid the invoice amount for the goods that were lost plus an additional 10%.

Transaction Costs

Selecting coverage, defining losses, and meeting other insurance requirements can be very burdensome for both insurers and their customers. In the year 2001, US property and casualty insurers spent more than $133 billion dollars in brokerage commissions, underwriting, and loss adjustment expenses. This amount represents approximately 39% of the premium dollars that they earned in that year.

Moreover, this amount does not reflect the significant costs that insurance buyers expended in getting coverage, substantiating their losses, and proving that those losses were covered under their insurance policies. The amount of time and expense that is involved in buying insurance and collecting on it can be very discouraging to insurance buyers, and it places new burdens on them when they are least able to deal with them.

Furthermore, it is not unusual for there to be disputes about what was covered, after a loss has occurred, and many claimants initiate litigation proceedings against their insurers to force them to pay. The inability to define in advance all the losses that will be covered by the policy makes it difficult for the insurance buyer to assess the value of the insurance policy and makes it equally hard on insurers to determine a fair premium.

The high cost of underwriting and loss adjusting are also huge deterrents to companies that would like to finance insurable risk. In effect, the large transaction costs associated with insurance represent a huge barrier to entry that discourages third parties from offering coverage and increases the cost of capital that is necessary to finance risk.

Reinsurance

Reinsurance is essentially insurance for insurance companies. Reinsurance enables insurers to buy protection against certain potential losses by paying premiums to another insurer called a reinsurer. Using this mechanism, an insurer can reduce its risk of loss by ceding risk on an individual basis (facultative reinsurance) or on a large number of risks (automatic reinsurance).

Reinsurance can be classified as either proportional or non-proportional in relation to the underlying insurance policies. Under proportional reinsurance, a reinsurer agrees to assume some proportionate share of the premiums and losses of the underlying insurance policies.

Quota share reinsurance is a type of reinsurance that is both automatic and proportional. Under this arrangement, a reinsurer agrees to accept a given percentage of every risk within a certain defined category that an insurer writes in return for the same percentage of premium. Thus, in the case of 30% quota share, a reinsurer must pay 30% of any loss that is sustained on exposures within a given risk class in return for receiving 30% of the premiums for that same class of risk.

By employing a coverage mechanism that is proportional and automatic, insurers and reinsurers can reduce the underwriting and loss adjustment expenses that would otherwise be a part of their reinsurance agreements. However, this technique is only used to share risks between insurers and reinsurers. The original insured is not involved in reinsurance transactions and gains no additional coverage as a result of it. Moreover, the insurer is obligated to pay the insured regardless of whether the reinsurer pays the insurer.

Derivatives

Derivatives are financial contracts whose pay-offs are based on the performance of an underlying asset, index, or reference rate. They include options, futures, forwards, and swaps. Derivatives may be used to speculate, by permitting investors to assume additional risk, or to hedge risk, by allowing entities to transfer risk to other market participants.

As a risk management tool, derivatives are commonly used to reduce market-based risks such as interest rates, currency rates, or price levels of commodities and financial assets. Because these types of risk are exogenous to any particular entity, they have certain qualities such as transparency and non-manipulability that permit them to be traded in a standardized and highly efficient way.

Generally speaking, companies can use financial contracts to hedge against changes in market rates and prices but not against their own idiosyncratic risk. Companies must manage these risks by themselves or, to the extent they can, buy insurance.

Securitization

Attempts have been made to standardize certain types of insurable risks, embed those risks in financial instruments, and trade them. During the 1990's, a number of efforts were made to develop catastrophe indices and related financial contracts that could be used to transfer the more exogenous parts of the insurance industry's loss experience. The most notable of these efforts were undertaken by the Insurance Services Office, Property claims Services, and IndexCo. Each of these companies produced and published catastrophe indices that were the basis for derivative contracts that were traded on either the Chicago Board of Trade or the Bermuda Commodities Exchange.

Such large-scale efforts to standardize insurable risk have largely been abandoned. However, a number of insurers and reinsurers have had some limited successes in creating bond instruments and other types of securities that have enabled them to transfer a portion of their insurable risks to others. These transactions typically involve transferring catastrophic risks such as earthquake and hurricane losses that are considered to be substantially outside of any particular insurer's and reinsurer's ability to control or influence. These transactions share some similarities to reinsurance, and it is not uncommon for reinsurers to be some of the largest investors in these deals.

None of these securities were designed to offer new forms of coverage or risk transfer options to a single insured that is not actively engaged in the insurance or reinsurance business. Moreover, these types of transactions have not been based on a single policy between an insured and an insurer. In addition, there is no standard relationship between the price that is charged and the coverage that is provided by a securitization in relation to the underlying insurance policies.

Instead, the price of a securitization is a function of how well a given transaction is received by the market at the time a deal is executed as well as the coverage that is provided. Although coverage may be described in a variety of ways, it is often begins at some relatively high loss threshold and typically includes multiple provisions that must be satisfied before any payments are due. Furthermore, securitizations are often “funded” to eliminate credit risk. This necessitates the inclusion of a large interest rate component that is typically absent in most insurance transactions which are often highly levered.

New Approach Needed

Given high transaction costs and the necessity of defining and proving losses, it becomes clear that insurance is a risk financing solution with significant limitations. Insurance proceeds are supposed to restore the policyholder to the same exact position that existed before the loss occurred. In practice, this is impossible. Collateral losses, deductibles, coinsurance, and coverage limits mean that the insured will never be fully recompensed for their losses. Clearly another approach is needed. Such an approach would permit more of the uncertainty associated with insurable losses to be objectified and would reduce the transactional burdens that are placed on the parties to an insurance contract.

### OBJECTS AND ADVANTAGES

The object of the invention is a method and process for financing expenses associated with insured loss events that we call Secondary Loss Expense Coverage. This method provides a new way to finance loss expenses that are currently either expensive or impossible to insure such as most types of collateral losses including such things as claim, administrative, management, accounting, legal, reputation maintenance, loss of income due to productivity impairment and other types of expenses.

Secondary Loss Expense Coverage eliminates most of the transaction costs that an insured would typically incur in purchasing insurance because it does not require lengthy or expensive underwriting and loss adjustment processes the way insurance does. As a result, it also eliminates more than 75% of the transaction costs that insurers typically have. These cost include sales, underwriting, and loss adjustment expenses and amount to approximately forty percent of property/casualty premium dollars in the United States. Reducing these costs increases profits for coverage sellers and enables them to reduce premiums for coverage buyers.

Secondary Loss Expense Coverage is extremely versatile from a contractual perspective and may be structured as an insurance policy or as some other type of contract. This is important because it enables companies and individuals that are not licensed as insurers to provide this coverage.

By substantially eliminating the underwriting and loss adjustment processes that are necessary to provide insurance-type coverage and by reducing the licensing limitations of insurance regulation, Secondary Loss Expense Coverage reduces barriers to entry and enables companies other than primary insurers to finance the risk of collateral losses. This gives insurance buyers access to new sources of risk capital and is particularly valuable in “hard” insurance markets when prices are high and coverage is difficult to obtain.

There are an infinite variety of ways to define the mathematical relationship between the price and coverage of Secondary Loss Expense Coverage in relationship to the premium paid for and the losses recovered under a separate insurance policy. This is useful because it enables coverage buyers and sellers to create risk transfer products that are tailored to their own specific needs.

Secondary Loss Expense Coverage also permits access to cheaper sources of capital than any other existing financial alternative. This is because individual insurers exhibit much greater loss volatility than does the insurance industry as a whole. By offering Secondary Loss Expense Coverage to the insureds of many different insurers, a coverage provider can mimic the loss experience of the industry and reduce its loss volatility. This will diminish the amount of capital that is needed to finance this risk while making the coverage providers significantly more attractive to investors since higher returns and lower profit volatility is exactly what investors want. These benefits can then be shared with coverage buyers in the form of lower premiums.

Furthermore, Secondary Loss Expense Coverage permits entities other than the insured to gain coverage based on insurance that someone else has. This might make sense in a situation where a company is highly dependent on a supplier and desires some collateral loss protection if the supplier sustains an insurable loss that would impair its ability to fulfill its contractual obligations.

Further objects and advantages are to provide a cheap, efficient, and convenient means of providing insurance buyers with an effective means of loss expense coverage. Other objects and advantages will become apparent from a consideration of the ensuing description and drawings.

### SUMMARY

This method permits the selection of loss expense coverage, underwriting, and loss determination processes of insurance to be performed by reference to an insurance policy.

### DRAWINGS—FIGURES

FIG. 1 shows the relationship between a Secondary Loss Expense Contract and an underlying insurance policy and outlines the various parties to these contracts.

FIG. 2 is a chart and table that demonstrates the relationship between Secondary Loss Expense Coverage and an insurance policy as well as the cost and benefits of this coverage.

FIG. 3 is a flowchart that demonstrates how simple and cost effective it is to perform underwriting and loss adjustment functions using Secondary Loss Expense Coverage, even for loss expenses that are hard to define or prove.

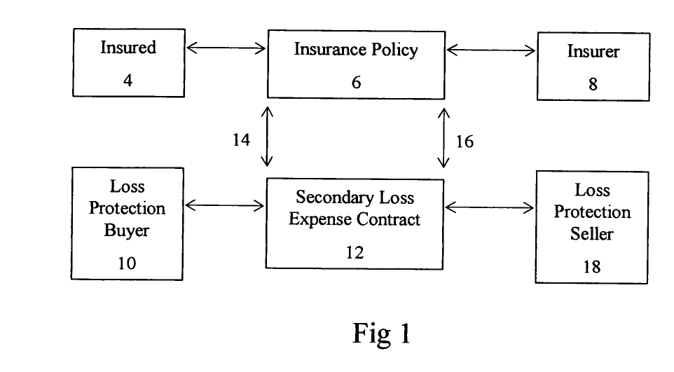

### DETAILED DESCRIPTION—FIGS. 1-3—PREFERRED EMBODIMENT

Product Overview

An overview of the relationship between a Secondary Loss Expense Contract and insurance policy is shown in FIG. 1. An insured 4 has an insurance policy 6′ with an insurer 8. A coverage buyer 10 may be the insured or another entity that has an interest in the well-being of the insured, such as a customer of the insured. The coverage buyer may desire to buy loss protection via the Secondary Loss Expense Contract 12.

The Secondary Loss Expense Contract has two pre-specified functional relationships to the insurance policy: the contract's losses 14 are a function of the losses that are recovered under the insurance policy; and the contract's premiums 16 are a function of the insurance policy's premiums. Although this relationship may be expressed in many different ways, it must give the buyer value and allow a loss protection seller 18 to make money. The loss protection seller 18 may be the same as the insurer 8 or may be some other entity that is interested in providing Secondary Loss Expense Coverage.

Some basic pricing and coverage rules describe how these criteria can be met. The value of Secondary Loss Expense Coverage is always established provided that the price of this coverage is the same as or less than the separate insurance coverage on a dollar of premium for dollar of insured limit. In essence, an insured has indicated that this coverage has value at this price by its willingness to pay this premium for the underlying insurance.

Thus, if the underlying insurance coverage is $10 million and cost $1 million, Secondary Loss Expense Coverage can be sold at a ratio of $10 of limit to $1 of premium and provide value to a protection buyer. In certain circumstances Secondary Loss Expense Coverage may be of much greater value than this relationship suggest. In which case, a higher Secondary Loss Expense premium could be charged and still provide value to the buyer. For example, in “hard market” conditions or in cases where loss costs are particularly difficult to determine, Secondary Loss Expense Coverage may be significantly more valuable to coverage buyer than the ratio of insured limit to premium on the underlying insurance policy.

Because it reduces underwriting and loss adjustment expenses by more than 75%, Secondary Loss Expense Coverage can be sold at a substantial discount to an underlying insurance policy and still provide value to both coverage buyers and coverage sellers. Assuming that underwriting and loss expenses are approximately 40% of insurance premiums, as they typically are for most US property/casualty insurance, a Secondary Loss Expense Coverage seller could reduce its premium rate by 30% in relation to the underlying insurance and still earn the same rate of return that the insurance company would earn on the underlying insurance policy. Using this assumption, the coverage provider in the example above could offer this coverage at a ratio of $10 of limit for $0.70 of premium.

Because Secondary Loss Expense Coverage substantially eliminates traditional insurance transaction costs, it reduces important barriers to entry in the insurance market and allows new entities to offer this type of coverage.

Cost/Benefit Analysis

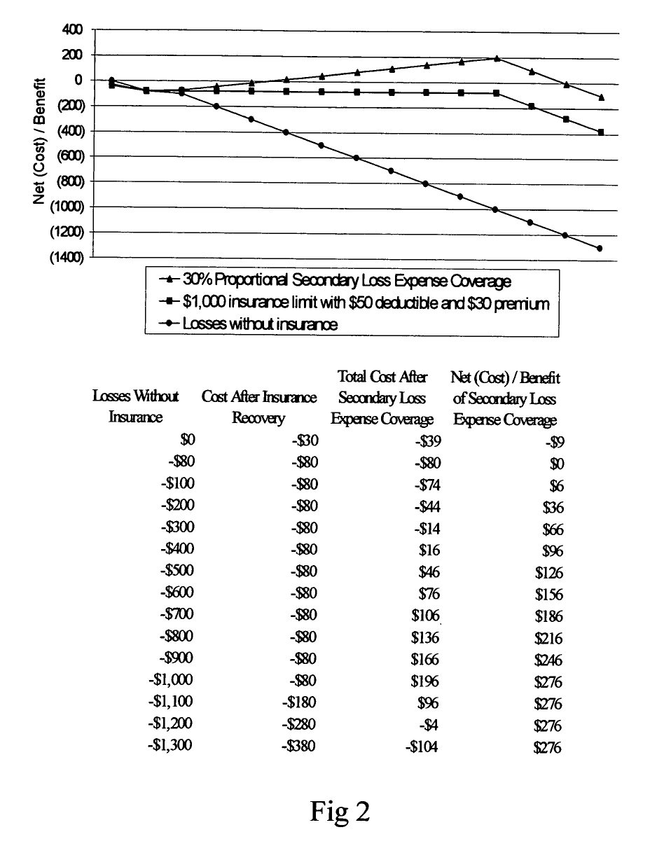

FIG. 2 shows an example of Secondary Loss Expense Coverage and illustrates its cost and benefits in relation to an insurance policy. In this example, an insured is concerned about insured losses that might range from $0 to $1000. The insured recognizes that there are likely to be collateral losses that are uninsurable over this range of loss experience and would like to obtain coverage for them if possible. The insured has three choices.

a. Buy no insurance and suffer losses as they occur.

b. Purchase an insurance policy for a premium of $30 that contains a deductible of $50 and an insured limit of $1000.

c. Buy the insurance policy and supplement it by purchasing Secondary Loss Expense Coverage equal to 30% of the insurance policy on a proportional basis. This would cost 30% of the insurance policy's premiums, or an additional $9, and would pay 30% of any losses that are recovered under the insurance policy.

The graph in FIG. 2 shows the net cost or benefit of each of these options over the relevant range of loss experience. The total cost or benefit equals the loss amount minus premiums and deductibles, plus any insurance and any Secondary Loss Expense Coverage recoveries.

The $30 cost of insurance premiums and the $50 deductible prevent the insurance option from breaking even until there has been at least $80 of insurable loss. This breakeven point for insurance would be higher to the extent that there are collateral losses that are not insurable. Putting aside the issue of collateral losses, the cost of the insurance premium and the presence of an insurance deductible make it impossible for the insurance buyer to ever be made whole by insurance. As a result, the line representing insurance will always be below the $0 line in the chart regardless of the specifics of a particular insurance policy.

The 30% proportional Secondary Loss Expense Coverage also provides significant benefits to the insured for insured losses that are greater than $80. However, as the loss experience gets worse, Secondary Loss Expense Coverage not only makes up for the premiums and the deductible that the insured paid, but also offers the ability to cover the additional collateral losses that the insured is concerned about. These losses cannot be covered in an economically feasible way by traditional insurance because they are too difficult to define in advance or to prove after the fact.

Method of Underwriting and Loss Adjusting

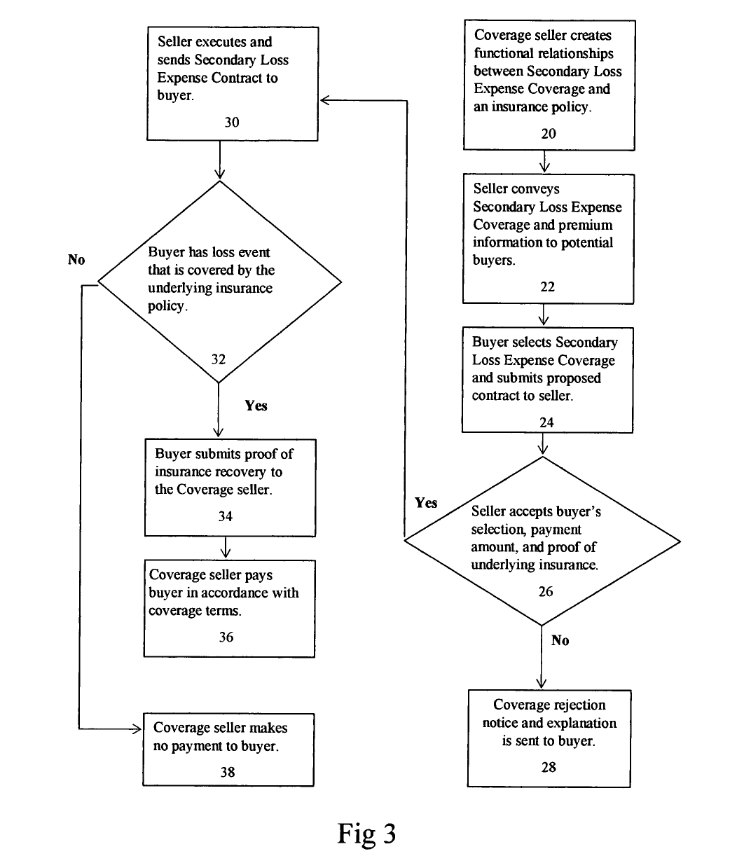

The flowchart in FIG. 3 illustrates how an entity that desires to sell Secondary Loss Expense Coverage could use this business method to eliminate most of the work that is currently required to underwrite loss coverage and to adjust claims. First, a coverage seller creates two functional relationships 20. One relationship defines the losses covered by Secondary Loss Expense Coverage in terms of the losses that will be recovered under an insurance policy and the second relationship defines the premium of the Secondary Loss Expense Contract in terms of the premiums paid for an insurance contract. Next, the coverage seller communicates its willingness to offer coverage on these terms to potential buyers 22. For example, the following schedule might be used to communicate that the coverage seller is willing to provide Secondary Loss Expense Coverage on a basis that is proportional to the underlying insurance.

| Coverage | Price |
|---|---|
| 10% of insured loss recoveries | 10% of insurance premiums |
| 15% of insured loss recoveries | 15% of insurance premiums |
| 20% of insured loss recoveries | 20% of insurance premiums |
| 25% of insured loss recoveries | 25% of insurance premiums |
| 30% of insured loss recoveries | 30% of insurance premiums |

Next, a buyer selects the most appropriate coverage amount based on her expectation of how much additional loss expense she might have over her insurance coverage and submits a proposed contract to the coverage seller for execution 24.

The coverage seller reviews the buyer's coverage submission request along with proof of the underlying insurance policy and payment 26. If there is something wrong with the submission, it would be rejected with an explanatory note sent back to the buyer 28. For example, the buyer may not have submitted proper proof that she had an insurance policy in force or may not have sent the proper payment amount.

Assuming the coverage submission is accepted, the coverage seller would send an executed contract to the buyer 30. This contract could be issued in the form of an insurance policy or some other type of contract.

If the Secondary Loss Expense Coverage buyer has a loss event 32, the buyer submits proof of the payment that it received from its separate insurance contract to the Secondary Loss Expense Coverage seller 34. The Secondary Loss Expense Coverage seller pays the buyer in accordance with the contract terms 36. If the buyer does not receive a payment under its insurance policy, the Secondary Loss Expense Coverage seller would make no payment to the buyer 38.

Additional Embodiments

Although the basic methodology for Secondary Loss Expense Coverage remains the same as described above, there are numerous embodiments of this concept. This method can be applied to all types of insurance policies including property, casualty, health, and life insurance coverages. Secondary Loss Expense Coverage can be offered by both primary insurers and third parties such as other insurers, banks, or other types of entities. Furthermore, Secondary Loss Expense Coverage can be offered in the form of an insurance policy or take many other contract forms. Secondary Loss Expense Coverage may be offered in amounts that are directly proportional or indirectly related to the premiums paid and the losses that are recovered from an underlying insurance policy.

Advantages

From the description above it should be clear that this process satisfies many purposes that can not be accomplished via traditional insurance or any other financial technique, operation, or type of contract that is currently in use to fund additional loss expenses. By simplifying the insurance process, this method reduces the costs that are currently part of the insurance process by as much as 75%, eliminating the need:

(a) To define coverage in terms of loss events;

(b) To separately underwrite each risk;

(c) For an extensive and cumbersome sales process;

(d) For proof of actual losses; and

(e) For a lengthy or disputatious claims adjustment process by the coverage provider.

This methodology also:

(f) Permits buyers to receive coverage for losses that are currently difficult or impossible to insure;

(g) Allows entities to select the amount of coverage and relationship to underlying loss experience that best suits their needs;

(h) Allows insurers to offer a new form of coverage to their customers;

(i) Permits the coverage to be structured as insurance or as some other type of financial contract;

(j) Gives insurance buyers access to new sources of capital by permitting third parties to offer them coverage;

(k) Reduces the costs of coverage for both providers and insurance buyers permitting significant premium reductions;

(l) Permits non-insurers to offer loss coverage; and

(m) Introduces more price competition to the insurance market by reducing the huge infrastructure costs that have been necessary to offer coverage to insurance buyers.

Although the description above contains certain specifics, these should not be construed as limiting the scope of the invention but as merely providing illustrations of some of the presently preferred embodiments of this invention. Clearly this methodology can be applied in many ways to all types of insurance and can be structured as insurance or as other types of financial contacts or separate provisions of other contracts. Thus the scope of the invention should be determined by the appended claims and the legal equivalents, rather than by any particular example described above.

We claim:

1. A method for defining loss coverage and calculating premium based on the terms of an insurance policy:
(a) using a contract that enables an exchange of money between two parties, where the coverage buyer is someone other than an insurer or a reinsurer, such that said exchange is determined by two functional relationships to said insurance policy, where one said functional relationship defines loss coverage as a function of the recovery under said insurance policy and the other said functional relationship calculates the premium of said contract as a function of the premium of said insurance policy,
whereby simple and cost efficient coverage is provided for losses that are expensive to define or prove.

2. The contract of claim 1(a) that is structured as one or more provisions in any type of contract.

3. The functional relationships of claim 1(a) where said contract's premium and loss coverage are directly proportional to the premium charged and the losses recovered under said insurance policy.

4. The functional relationships of claim 1(a) where said contract's premium and loss coverage are not directly proportional to the premium charged and the losses recovered under said insurance policy.

5. A method for defining loss coverage and calculating premium based on the terms of an insurance policy:
(a) using a contract that enables an exchange of money between an insured and a party other than its insurer such that said exchange is determined by two functional relationships to said insurance policy, where one said functional relationship defines loss coverage as a function of the recovery under said insurance policy and the other said functional relationship calculates the premium of said contract as a function of the premium of said insurance policy,
whereby simple and cost efficient coverage is provided for losses that are expensive to define or prove.

6. The contract of claim 5(a) that is structured as one or more provisions in any type of contract.

7. The functional relationships of claim 5(a) where said contract's premium and loss coverage are directly proportional to the premium charged and the losses recovered under said insurance policy.

8. The functional relationships of claim 5(a) where said contract's premium and loss coverage are not direct proportional to the premium charged and the losses recovered under said insurance policy.

9. A method for defining collateral loss coverage and calculating collateral loss premiums based on the terms of an insurance policy:
(a) using a contract that enables an exchange of money between two parties, where the coverage buyer is someone other than an insurer or a reinsurer, such that said exchange is determined by two functional relationships to said insurance policy, where one said functional relationship defines loss coverage as a function of the recovery under said insurance policy and the other said functional relationship calculates the premium of said contract as a function of the premium of said insurance policy,
whereby simple and cost efficient coverage is provided for losses that are expensive to define or prove.

10. The contract of claim 9(a) that is structured as one or more provisions in any type of contract.

11. The functional relationships of claim 9(a) where said contract's premium and loss coverage are directly proportional to the premium charged and the losses recovered under said insurance policy.

12. The functional relationships of claim 9(a) where said contract's premium and loss coverage are not direct proportional to the premium charged and the losses recovered under said insurance policy.

13. A method for defining collateral loss coverage and calculating collateral loss premiums based on the terms of an insurance policy:
(a) using a contract that enables an exchange of money between a party, other than the insured or the insurer, that is purchasing collateral loss protection and another party such that said exchange is determined by two functional relationships to said insurance policy, where one said functional relationship defines loss coverage as a function of the recovery under said insurance policy and the other said functional relationship calculates the premium of said contract as a function of the premium of said insurance policy,
whereby simple and cost efficient coverage is provided for losses that are expensive to define or prove.

14. The contract of claim 13(a) that is structured as one or more provisions in any type of contract.

15. The functional relationships of claim 13(a) where said contract's premium and loss coverage are directly proportional to the premium charged and the losses recovered under said insurance policy.

16. The functional relationships of claim 13(a) where said contract's premium and loss coverage are not direct proportional to the premium charged and the losses recovered under said insurance policy.

17. A method for defining loss coverage and calculating premiums based on the terms of an insurance policy:
(a) using a standardized methodology so as to substantially reduce the cost of the underwriting and claims handling expenses,
(b) using a contract that offers loss protection,
(c) using a process that enables a coverage seller to create a portfolio of contracts that mimics the loss experience of many different insurance companies,
whereby coverage sellers may offer a new type of cost-effective loss protection that also enables them to generate a high return on their capital.
